(19) United States
(12) Patent Application Publication
(10) Pub. No.: US 2014/0328508 A1
(43) Pub. Date: Nov. 6, 2014

(54) HAT WITH SOUND PLAYING DEVICE

(71) Applicants: Emily Ann Jacks, Commerce City, CO (US); Louis Karl Barth, Commerce City, CO (US)

(72) Inventors: Emily Ann Jacks, Commerce City, CO (US); Louis Karl Barth, Commerce City, CO (US)

(21) Appl. No.: 13/875,327

(22) Filed: May 2, 2013

(51) Int. Cl. H04R 1/10

(52) U.S. Cl. CPC H04R 1/105
USPC 381/376

(57) ABSTRACT

A hat of the present invention includes at least opening to define a pocket extending along the peripheral edge of the hat. A speaker device includes a plurality of components removably connected with one another to form a uniformed piece thereby allowing the user to insert the speaker device into the pocket to allow the user to wear the hat and listed to sounds. The speaker device includes a pair of speakers, a controller unite connected to one of the speakers and a battery unit including a battery for supplying power to the speakers and the controller unit. The battery unit is connected to another speaker.

### FIELD OF THE INVENTION

The present invention relates generally to a hat, and more particularly, to a hat with sound playing function.

### BACKGROUND OF THE INVENTION

When using mobile audio devices, it is helpful to deliver the sound as close as possible to the user's ears for better audio perception. However, using earbuds or headphones to deliver the sound also tends to block the listener from perceiving other sounds, such as emergency alarms, phone rings, or another person's words. Consequently, such conventional forms of audio delivery may place the user (and others around him/her) in danger if a warning or alarm is not heard due to the use of earbuds or earphones.

Prior art is replete with various designs of hats with sound playing function. U.S. Pat. No. 5,410,746 to Gelber discloses headgear, such as a cap having a crown, a brim and an internal sweatband or flap, combined with an electronic receiving device, such as a radio, which is connected to the inner surface of the flap by a first double sided adhesive strip. Another prior art reference, such as U.S. Pat. No. 5,510,961 to Peng discloses a cap structure with sound recording and generating means and warning lights includes digitalized sound recording and releasing means and light emitting diodes on a visor.

Alluding to the above, U.S. Pat. No. 7,031,068 to Himmele discloses a hands-free binocular visor headgear for viewing sporting and other events where it is desirable to use binoculars but also have the free use of the hands. U.S. Pat. No. 7,862,194 to Seade teaches an embodiment of a baseball style cap and stereo combination having a crown, a brim/bill, a sweatband, and two amplified stereo speakers concealed within the brim/bill is disclosed. The baseball-style cap combination further includes a battery holder/forehead cushion housing a battery holder concealed within an inner surface of the baseball-style cap combination by a flap. Also included are wires connecting the battery holder to an amplifier concealed within the sweatband and wires connecting the amplifier to the speakers. A stereophonic music generator sends a music signal which is provided to the amplifier by any suitable means of communication, like an audio cord.

Another prior reference such as U.S. Pat. No. 8,107,664 to Mao discloses a cap with a bluetooth headset which is in the technology field of daily supplies, including a cap body. The cap body has a bluetooth headset which comprises a transceiver and two acoustic generators on the right and left respectively, the transceiver is set at either position of the cap body, each of the acoustic generators are respectively set at a side of the cap body corresponding to the ears. A piece of lead is used to connect the transceiver and acoustic generators. Compared with prior art, the invention provides dual-track voice, so as to make communication clearer, reduce noise influence on environment. The acoustic generators are fixed on both sides of the cap body so firmly that it is not prone to be dropped and lost, even under movement states, it is still very firm.

United States Patent Publication No. 20110088143 to Lee teaches a hat with sound playing function includes a hat body, a brim extending from the hat body and at least one slim speaker. The brim has a supporting layer and a decorating layer covering a surface of the supporting layer. The at least one slim speaker is disposed between the supporting layer and the decorating layer.

Still another prior art, such as United States Patent Publication No. 20110116673 to Lewis teaches a wireless personal audio equipment arrangement comprising: a hat, a control circuit including a microwave link receiver carried by the hat, the control circuit outputting signals to speakers, and acoustic chambers conducting sound signals produced by the speakers to earpieces carried by the hat.

The opportunity always exists for an improved hat with sound playing function that easy to manufacture and wear.

### SUMMARY OF THE INVENTION

A hat of the present invention includes at least one opening to define a pocket extending along the peripheral edge of the hat. A speaker device includes a plurality of components removably connected with one another to form a uniformed piece thereby allowing the user to insert the speaker device into the pocket to allow the user to wear the hat and listen to sounds. The speaker device includes a pair of speakers, a controller unit connected to one of the speakers and a battery unit including a battery for supplying power to the speakers and the controller unit. The battery unit is connected to another speaker.

A carrier member such as a band defines terminal ends. One terminal end is connected to the controller unit. The other terminal end is connected to the battery unit. At least one wire extends either through the band or is connected to the band. The wire is operably communicated with the speakers, the controller unit and the battery unit to supply power thereto.

In alternative embodiment of the present invention, the speakers, the controller unit, and the battery unit are operably connected with one another by male/female connectors thereby allowing the user to separate the device into several pieces in order to easily transport the device when required or when one of the elements such as the speakers, the controller unit, the band, and the battery unit need to be services or replaced with new ones.

Still another alternative embodiment of the present invention includes a head band having at least one opening or slot to define a pocket extending along the peripheral edge of the head band. The speaker device is inserted by the user therein to allow the user to wear the head band and listen to sounds. The speaker device includes the pair of speakers, the controller unit connected to one of the speakers and the battery unit including the battery for supplying power to the speakers and the controller unit. The battery unit is connected to another speaker.

The carrier member such as the band defines the terminal ends. One terminal end is connected to the controller unit. The other terminal end is connected to the battery unit. The wire extends either through the band or is connected to the band. The wire is operably communicated with the speakers, the controller unit and the battery unit to supply power thereto.

In yet another alternative embodiment of the present invention includes an earmuff device having a housing defining a central portion extending to terminal ends with each of the terminal ends further presenting a semicircular portions with peripheral edge extending beyond sides of having at least one opening or slot to define a pocket extending along the peripheral edge of the earmuff device. The speaker device is inserted by the user therein to allow the user to wear the earmuff device and listen to sounds. The speaker device includes the pair of speakers, the controller unit connected to one of the speakers and the battery unit including the battery for supplying power to the speakers and the controller unit. The battery unit is connected to another speaker.

The carrier member such as the band defines the terminal ends. One terminal end is connected to the controller unit. The other terminal end is connected to the battery unit. The wire extends either through the band or is connected to the band. The wire is operably communicated with the speakers, the controller unit and the battery unit to supply power thereto.

An advantage of the present invention is to provide the hat with sound playing function that is easy to manufacture.

Another advantage of the present invention is to provide a new hat with sound playing function that is light in weight and is comfortable to wear.

Still another advantage of the present invention is to provide a new design of a hat with sound playing function that can be inserted in any other types of hats, headbands, and earmuffs designed by the manufacturer.

Still another advantage of the present invention is to provide a new design of a hat with sound playing function that can be assembled and disassembled as needed or when one of the components needs to be replaced or serviced.

Other objects, features, and advantages of the present invention will become apparent upon consideration of the following detailed description of a preferred embodiment thereof, when taken in conjunction with the appended drawing.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a front view of a hat with sound playing function wherein the hat is illustrated in phantom to show positioning of a speaker device;

FIG. 2 illustrates a front view of the hat of FIG. 1 with the speaker device inserted into an opening defined in the hat to receive the speaker device and hide the speaker device inside the hat;

FIG. 3 illustrates a front view of a controller device of the speaker device;

FIG. 4 illustrates an alternative view of the speaker device wherein all components of the speaker device, such as speakers, a battery unit, the controller device and a band are removably connected with one another;

FIG. 5 illustrates another alternative embodiment of the present invention wherein the speaker device is incorporated within a head band; and

FIG. 6 illustrates still another alternative embodiment of the present invention wherein the speaker device is incorporated within an earmuff device.

### DESCRIPTION OF THE INVENTION

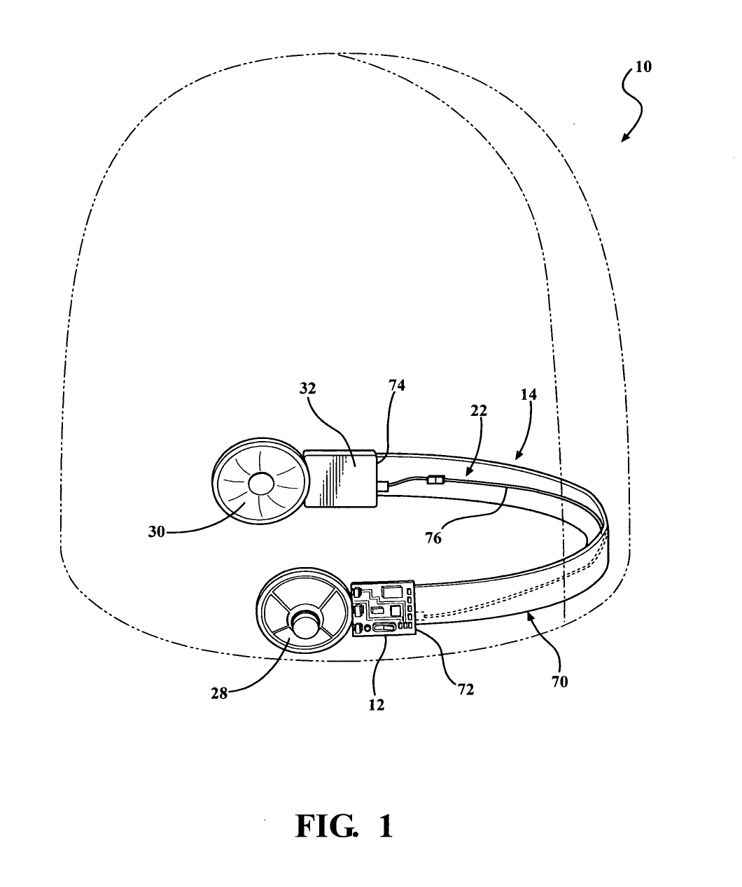

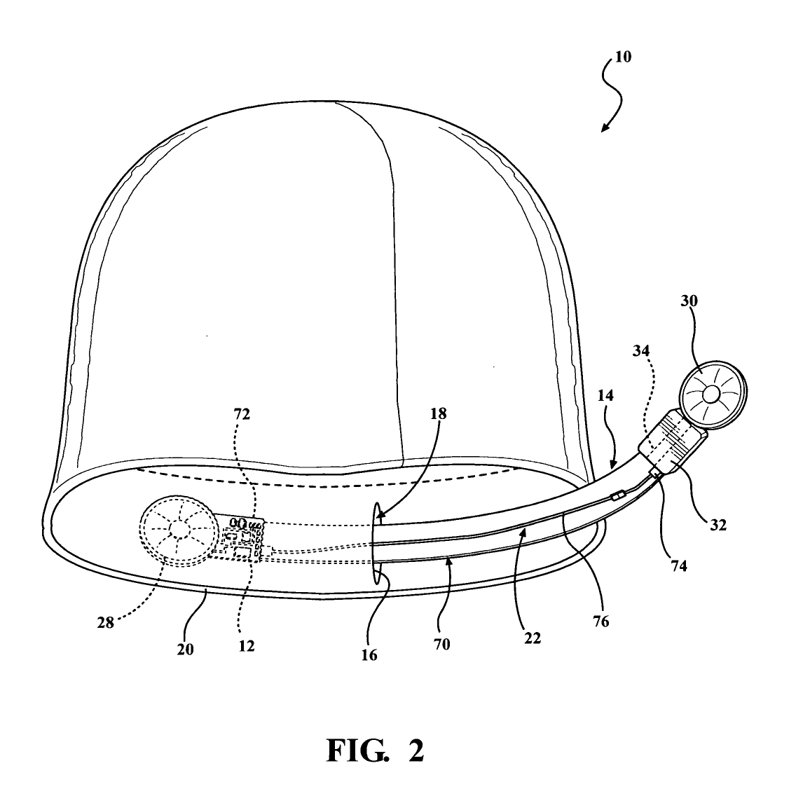

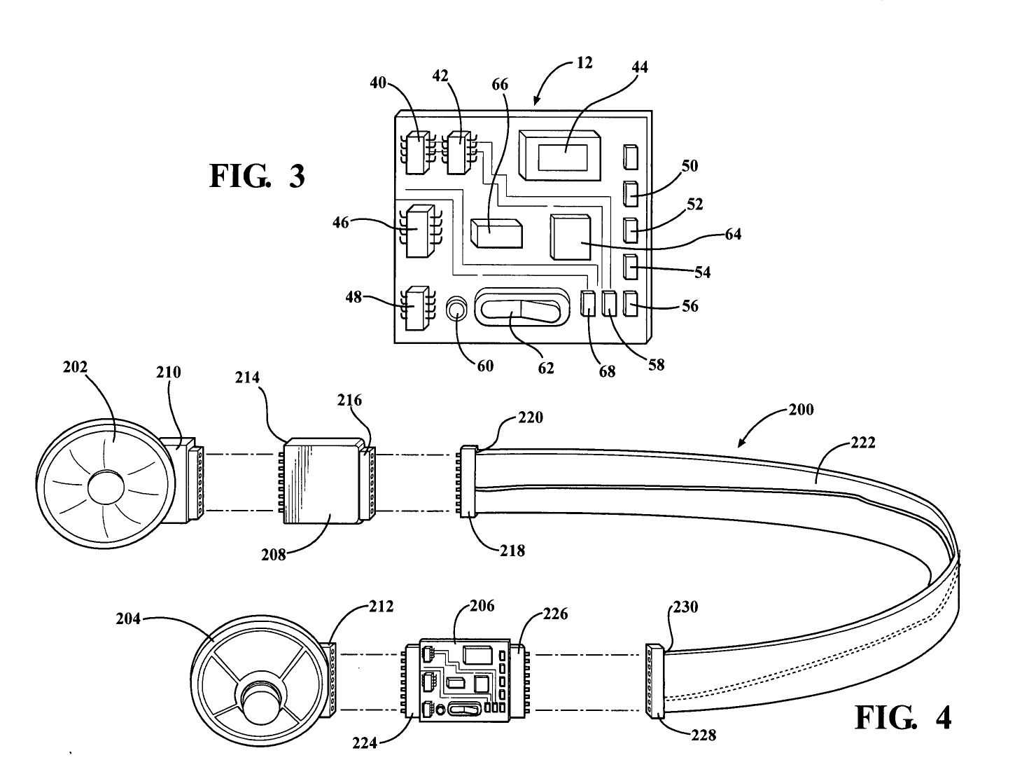

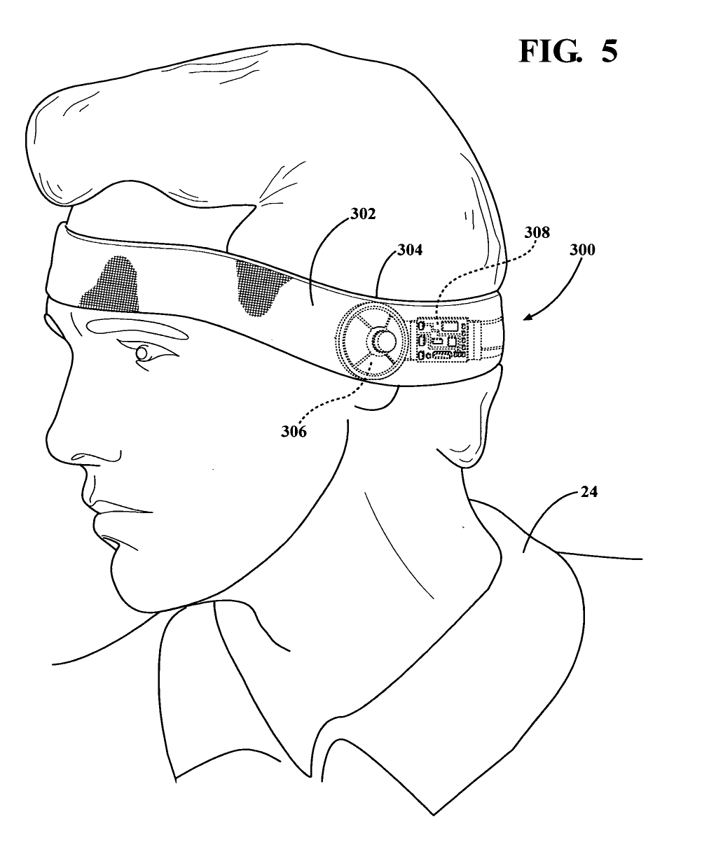

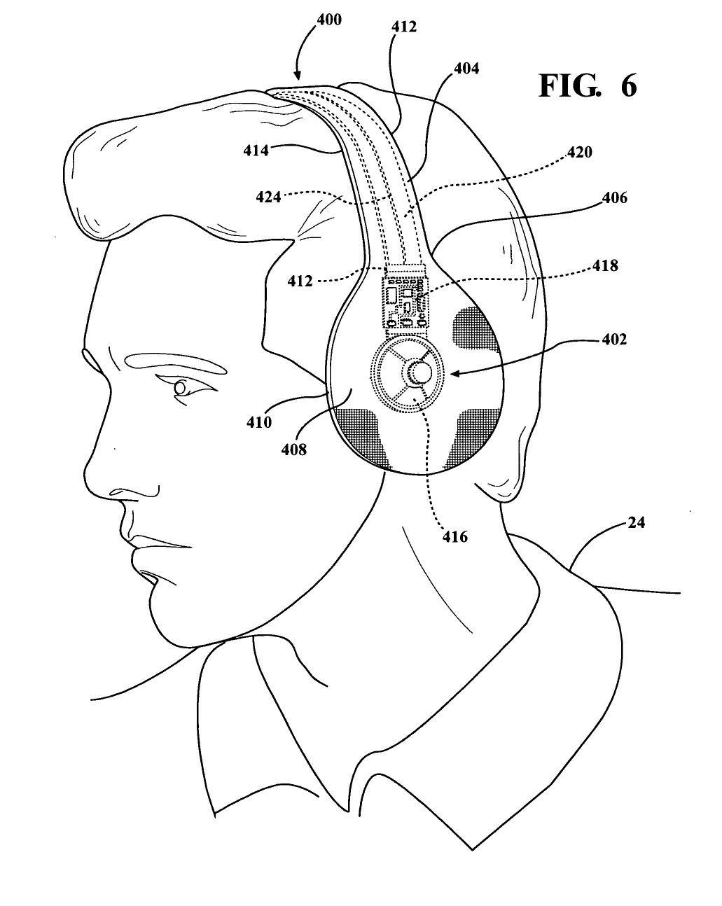

Referring to Figures, wherein like numeral indicated like or corresponding part, a hat with sound playing function is generally shown at 10 in FIGS. 1 and 2. FIG. 3 illustrates a controller device, generally shown at 12 of a speaker device 14. FIG. 4 illustrates an alternative view of the speaker device, generally shown at 200. FIG. 5 illustrates another alternative embodiment of the speaker device, generally shown at 300, wherein the speaker device 300 is incorporated within a head band 302. FIG. 6 illustrates still another alternative embodiment of the present invention, wherein the speaker device, generally shown at 400 is incorporated within an earmuff device 402.

Referring now to FIGS. 1 through 3, the hat 10 of the present invention is shown. The hat 10 can be made from a fabric, leather, polymeric and any one non-polymeric materials without limiting the scope of the present invention. The hat 10 can be soft, foldable or rigid. The hat 10 includes at least one opening or slot 16 to define a pocket, generally indicated at 18 extending along the peripheral edge 20 of the hat 10. The speaker device 14 includes a plurality of components connected with one another to form a uniformed piece, generally indicated at 22, thereby allowing the user 24 to insert the speaker device 14 into the pocket 18 to allow the user 24 to wear the hat 10 and listed to sounds. The speaker device 14 includes a pair of speakers 28 and 30, the aforementioned controller unit or device 14 connected to one of the speakers 28 and a battery unit 32 including a battery 34 for supplying power to the speakers 28 and 30 and the controller unit 14. The battery 34 may include a lithium ion battery and any other batteries of any shapes such as tubular or prismatic without limiting the scope of the present invention. The battery unit 32 is connected to another speaker 30.

Referring to FIG. 3, the controller unit 14 includes a USB charging port 40, a battery charging regulator 42, a Bluetooth module 44, a AM/FM receiver 46, a remote controller module 48, a battery connection uplink 50, speaker connection uplinks 52 and 54, a volume remote uplink 56, an ON/OFF remote uplink 58, a solar charging port 60, a manual mode button 62, an AM/FM/FRS antenna 64, a family radio service module 64, a mode changer connection uplink 66, and a manual volume regulation button 68. All of the aforementioned components are operably connected with one another.

A carrier member such as a band, generally indicated at 70, defines terminal ends 72 and 74. One terminal end 72 is connected to the controller unit 14. The other terminal end 74 is connected to the batter unit 32. The band 70 is formed from a polymeric material or a non-polymeric material without limiting the scope of the present invention. The band 70 is flexible to allow the user to easily insert the speaker device in to the slot of the hat 10. At least one wire 76 extends either through the band 70 in the channel defined therein of is connected to the band 70. The wire 76 is operably communicated with the speakers 28, 30, the controller unit 14 and the battery unit 32 to supply power thereto. The band 70 is fabricated from a flexible material, and when connecting the pair of speakers 28, 30, the controller unit 14, and the battery unit 32 the band 70 forms a unitary element thereby allowing the user 24 to flex the unitary element to insert the unitary element into the opening 16 and move the unitary element around the pocket thereby completely hide the unitary element within the pocket to allow the user 24 to listed to sounds as the user 24 wears the hat 10.

In alternative embodiment of the present invention, as shown at 200 in FIG. 4, the speakers 202 and 204, the controller unit 206, and the battery unit 208 are operably connected with one another by male/female connectors. For example, the speakers 202 and 204 include female connectors 210 and 212, the battery unit 208 includes a male connector 214 at one end operably engage the female connector 210 of the speaker 202 and a female connector 216 to engage with a male connector 218 extending from one of the terminal ends 220 of the band 222. The controller unit 206 includes a pair of male connectors 224 and 226. The male connector 224 engages with the female connector 212 of the speaker 204 and another male connector 226 engages with a female connector 228 extending from another terminal end 230 of the band 222.

The connections defined between the speakers 202 and 204, the controller unit 206, and the battery unit 208 allow the user 24 to separate the device 200 into several pieces in order to easily transport the device 200 when required or when one of the elements such as the speakers 202 and 204, the controller unit 206, and the battery unit 208, and the band 222 need to be services or replaced with new ones. Those skilled in the art will appreciate that the connectors disclosed herein are not intended to limit the scope of the present invention. Other connector types and configurations can be used.

FIG. 5 illustrates another alternative embodiment of the speaker device, generally shown at 300, wherein the speaker device 300 is incorporated within a head band 302. The head band 302 presents at least one opening or slot to define a pocket extending along the peripheral edge 304 of the head band. The speaker device 300 is inserted by the user 24 therein to allow the user 24 to wear the head band 300 and listed to sounds. The speaker device 300 includes the pair of speakers (only one is shown in phantom at 306), the controller unit 308 connected to one of the speakers 304 and the battery unit including the battery (not shown) for supplying power to the speakers and the controller unit 308. The battery unit is connected to another speaker (not shown).

FIG. 6 illustrates still another alternative embodiment of the present invention, wherein the speaker device, generally shown at 400 is incorporated within an earmuff device, generally indicated at 402. The earmuff device 402 has a housing 404 defining a central portion extending to terminal ends (one is shown at 406) with each of the terminal ends further presenting semicircular portions (only one is shown at 408) with a peripheral edge 410 extending beyond sides 412 and 414 of the housing 404. The speaker device 400 is inserted by the user 24 into the housing 404 to allow the user 24 to wear the earmuff device 402 and listed to sounds. The speaker device 400 includes the pair of speakers (only one is shown in phantom at 418), the controller unit, shown in phantom at 418, connected to one of the speakers 416 and the battery unit including the battery (not shown) for supplying power to the speakers 416 and the controller unit 418. The battery unit is connected to another speaker.

The carrier member such as the band 420 defines the terminal ends. One terminal end is connected to the controller unit 418. The other terminal end is connected to the batter unit. The wire 424 extends either through the band 420 or is connected to the band 420. The wire 424 is operably communicated with the speakers 416, the controller unit 418 and the battery unit to supply power thereto.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A hat with a sound playing device comprising;
a hat portion extending to a peripheral edge and including at least one opening to define a pocket extending along said peripheral edge of said hat portion,
a speaker device presenting a pair of speakers, a controller unit, and a battery unit for supplying power to said speakers and said controller unit, and
a band fabricated from a flexible material, said band connecting said pair of speakers, said controller unit, and said battery unit thereby forming a unitary element thereby allowing a user to flex said unitary element to insert said unitary element into said at least one opening and move said unitary element around said pocket thereby completely hide said unitary element within said pocket to allow the user to listed to sounds as the user wears said hat portion.

2. A hat with a sound playing device as set forth in claim 1, wherein said controller unit includes a USB charging port, a battery charging regulator, a Bluetooth module, a AM/FM receiver, a remote controller module, a battery connection uplink, speaker connection uplinks, a volume remote uplink, an ON/OFF remote uplink, a solar charging port, a manual mode button, an AM/FM/FRS antenna, a family radio service module, a mode changer connection uplink, and a manual volume regulation button.

3. A hat with a sound playing device as set forth in claim 1, including a plurality of male and female connectors thereby connecting said speakers, said controller unit, and said battery unit with one another.
